(19) United States
(12) Patent Application Publication
(10) Pub. No.: US 2022/0194178 A1
(43) Pub. Date: Jun. 23, 2022

(54) AIR VENT FOR A VEHICLE

(71) Applicant: DAIMLER AG, Stuttgart (DE)

(72) Inventor: Reinhold HENNE, Haigerloch (DE)

(21) Appl. No.: 17/610,802

(22) PCT Filed: Apr. 28, 2020
(86) PCT No.: PCT/EP2020/061789

§ 371 Date: Nov. 12, 2021

(30) Foreign Application Priority Data
May 13, 2019 (DE) 10 2019 003 366.3

(51) Int. Cl. B60H 1/34; B60Q 3/20; B60Q 3/64

(52) U.S. Cl. CPC B60H 1/3421; B60Q 3/20; B60Q 2500/20; B60H 2001/3464; B60H 2001/3478; B60Q 3/64

(57) ABSTRACT

A vehicle air vent includes an illuminating device having an illuminating element, a light conductor optically coupled to the light source and the illuminating element, and a bearing having a first bearing segment and a second bearing segment mounted pivotably and/or rotatably on the first bearing segment. The first bearing segment has a light decoupling segment and the second bearing segment has a light coupling element. A wall of the outer air conducting element surrounds a wall of a roller-shaped inner air conducting element, and the inner air conducting element can be pivoted in relation to the outer air conducting element and the housing around a pivoting axis running transversely to the current direction predetermined by the channel. The pivoting axis runs perpendicularly to the pivoting axis of the outer air conducting element. A pivoting point and/or rotating point of the bearing coincide or coincides with an imaginary intersection of the pivoting axis of the air conducting element.

### BACKGROUND AND SUMMARY OF THE INVENTION

Exemplary embodiments of the invention relate to an air vent for a vehicle.

A ventilation device formed as a ball jet for a motor vehicle is known from DE 10 2014 018 302 A1. The ventilation device comprises a housing having an air channel and an air outlet. An air conducting element is moveably arranged in the housing for setting an airflow, wherein the air conducting element has a visible side with an illumination surface. The air conducting element has slats that deflect the airflow. An illuminating element is provided with the aid of which the illumination surface of the air conducting element can be illuminated. The housing comprises a bearing with a bearing surface, on which the air conducting element is rotatably and pivotably arranged. The bearing has a light decoupling region. The air conducting element sectionally consists of a light conducting material having a light coupling region connected in a light conductive manner to the illumination surface. The light coupling region of the air conducting element and the light decoupling region of the bearing are arranged in relation to each other in such a way that light from the light decoupling region of the bearing can be coupled into the light coupling region of the light conducting element. The bearing surface has a spherical, in particular ball-shaped, outer geometry, wherein the light decoupling region of the air conducting element is arranged on the spherical bearing surface. The air conducting element comprises a spherical cap comprising the light coupling region, by means of which spherical cap it is rotatably and pivotably mounted on the ball-shaped outer geometry. The illuminating element is arranged outside the bearing, wherein a light conductor is provided that connects the illuminating element to the light decoupling region. Thus, central points of the ball-shaped outer geometry and the spherical cap coincide with a central point of a ball bearing of the ball jet.

Furthermore, an air jet for guiding an airflow from an air supply channel or from an air supply line in heating, ventilation, or air-conditioning systems for passenger chambers in motor vehicles is known from DE 10 2010 036 691 A1. The air jet consists of a housing, which can be inserted into a wall aperture or can be fixed behind this and which has a rear port for an air supply channel or an air supply line and a front air outflow opening. An insert that deflects the airflow and can be pivoted in one direction is provided inside the housing, wherein narrow ribs or webs are provided in the insert or on the rear of the insert in the front view running transversely to the longitudinal direction of the insert which support a bracket on an illuminating element.

EP 3 156 272 A1 describes an air vent consisting of a housing having an opening for supplying an airflow and an opening for channeling out the supplied airflow. The airflow is guided to the air vent out of an air supply shaft or out of an air supply line in heating, ventilation, or air-conditioning systems for passenger chambers in motor vehicles. The air vent can be inserted with its housing into a wall aperture or can be mounted behind it. An insert mounted rotatably and pivotably around a bearing with an arrangement for guiding and deflecting the supplied airflow and an element arranged centrally in the insert are arranged in the housing. The insert is connected to the arrangement for guiding and deflecting the supplied airflow. The bearing is arranged on the central longitudinal axis of the housing. The mounting is carried out by means of a bearing, wherein a light-technical coupling of the second light conductor is provided in the bearing, which serve to illuminate the air vent.

JP 2010 137 816 A describes a ventilation grille for a vehicle, wherein a light source is provided on a side wall outer surface of a grille body.

Exemplary embodiments of the invention are directed to a novel air vent for a vehicle.

An air vent for a vehicle comprises a housing having a channel that can be flowed through by air. Furthermore, the air vent has an air conducting element, which can be pivoted in relation to the housing around a pivoting axis running transversely to a current direction predetermined by the channel, and an illuminating device, comprising an illuminating element, at least one light source arranged outside the air conducting element and at least one light conductor optically coupled to the light source and the illuminating element. Furthermore, the air vent comprises a bearing, comprising a first bearing segment formed spherically and fixed at least indirectly on the housing and a spherical second bearing segment corresponding to the first bearing segment and fixed on the illuminating element, the bearing segment being pivotably and/or rotatably mounted on the first bearing segment. Here, the first bearing segment for optical coupling of the illuminating element to the light conductor comprises a light decoupling surface and the second bearing segment comprises a light coupling surface.

According to the invention, the air conducting element is formed as a roller-shaped outer air conducting element. A wall of the outer air conducting element surrounds a wall of a roller-shaped inner air conducting element, wherein the inner air conducting element can be pivoted in relation to the outer air conducting element and the housing around a pivot axis running transversely to the current direction predetermined by the channel. For example, the inner air conducting element is pivotably mounted for this on the outer air conducting element. Furthermore, the pivot axis runs perpendicularly to the pivot axis of the outer air conducting element, wherein a pivoting point and/or rotating point of the bearing coincide(s) with an imaginary intersection of the pivoting axes of the air conducting elements.

Due to the fact that the pivoting point and/or rotating point of the bearing coincide with the imaginary intersection of the pivoting axes of the air conducting elements, the optical coupling of the light conductor to the illuminating element is carried out centrally or in the middle in the air vent without the pivoting regions of the air conducting elements being limited. Here, the air conductor and the illuminating element make possible an illumination of the air vent or of sections thereof, for example an indirect illumination, without the light source being visible to a vehicle occupant. This means that an illuminant no longer has to be moveably arranged in a corresponding air vent. Instead, the illuminating element can be arranged stationarily in relation to the housing. The light guide to the illuminating element is carried out via the optical coupling of the light conductor in the bearing, such that the light of the light source is conducted from the light source to the illuminating element by means of light paths that do not change in terms of their relative spatial configuration when adjusting the air guiding element in the bearing. In doing so, light can be emitted in one color, which correlates to a change of the desired temperature. For example, with a desired decrease of the desired temperature, light with a blue color can be emitted, with a desired increase of the desired temperature, light with a red color. The light color can be chosen automatically to influence an opinion of the vehicle occupant. Alternatively, a manual selection by a vehicle occupant is also possible.

In a possible embodiment of the air vent, the illuminating element is formed to at least sectionally illuminate a visible side of the air conducting element and/or to at least sectionally illuminate a visible side of the inner air conducting element. In doing so, an indirect illumination at least of one of the air conducting elements is generated, which makes it possible, inter alia, for a vehicle occupant to be able to easily detect and operate the air vent in darkness.

In a further possible embodiment of the air vent, the illuminating element is a component of an actuation element arranged centrally between the wall of the inner air conducting element or forms this, wherein the actuation element is mechanically coupled to the inner air conducting element and the outer air conducting element and, in the event of a pivoting around the bearing, causes a pivoting of the inner air conducting element and/or the outer air conducting element around the respectively corresponding pivoting axis. The coupling of the actuation element to the outer air conducting element is carried out indirectly, for example, via the coupling to the inner air conducting element, which in turn can be mounted on the outer air conducting element. Thus, a pivoting of the air conducting elements in a simple manner is possible by means of a centrally arranged actuation element.

In a further possible embodiment the air vent comprises a flap arrangement arranged in the channel having at least one flap, which is arranged pivotably inside the channel to change a free cross-section of the channel. By setting the free cross-section, an amount of outflowing air can be reliably controlled.

In a further possible embodiment of the air vent, the actuation element is coupled to a rotatable shaft, which coaxially surrounds the air conductor at least sectionally and comprises a frontal serration on an end facing away from the actuation element, the frontal serration being in engagement with a serration of a drive of the flap arrangement. A rotational movement of the actuation element causes a rotational movement of the shaft and a transmission of this to the drive of the flap arrangement for pivoting the at least one flap. Thus, the pivoting of the air conducting elements and, at the same time, the control of the flap arrangement can be actuated by means of an operating element. In doing so, a number of actuation elements for operating the air vent can be minimized and an intuitive and simple operation can be achieved.

In a further possible embodiment of the air vent, the shaft is coupled to the spherical first mounting element on the end facing towards the actuation element or comprises this. This enables a simple construction of the air vent with a small number of components with simultaneously high robustness, reliability, and longevity.

In a further possible embodiment of the air vent, the first mounting element is formed as a ball cup and the second bearing element is formed as a ball corresponding to the ball cup. Alternatively, the second bearing element is formed as a ball cup and the first bearing segment is formed as a ball corresponding to the ball cup. Such a formation of the bearing segments enables a pivoting of the air conducting element that can be carried out reliably, comfortably and with minimal force expenditure and simultaneously enables the rotational movement of the actuation element and the shaft.

In a further possible embodiment of the air vent, at least one radially protruding spigot is arranged on an outside of the ball. At least one slot-shaped recess running in the peripheral direction of the wall perpendicularly to the rotational direction of the actuation element is arranged on a wall of the ball cup, wherein the spigot protrudes into the recess and is in mechanical engagement with the ball cup. On one hand, the spigot arranged in the recess enables a transfer of a rotational torque when the actuation element rotates to the shaft. On the other hand, the pivoting movement is released to pivot at least one of the air conducting elements until reaching an end of the recess because of the slot-shaped formation of the recess.

In a further possible embodiment of the air vent, the actuation element comprises a gripping element at least sectionally surrounding the illuminating element, wherein the gripping element comprises a peripheral translucent or transparent light decoupling section running, in particular, coaxially in relation to a rotational axis of the actuation element and directed away from the rotational axis, the light decoupling section decoupling light decoupled inside the gripping element by means of the illuminating element. This design of the gripping element simultaneously enables a particularly unobtrusive light decoupling that also acts with high quality and, as a result of this, an indirect illumination of visible sections of the air conducting elements with an optically very high quality design of the actuation element.

In a further possible design of the air vent, the actuation element comprises a gripping element at least sectionally surrounding the illuminating element, wherein the gripping element comprises a translucent or transparent light decoupling section, which decouples light decoupled inside the gripping element in the running direction of the rotational axis by means of the illuminating element. For example, the light decoupling section runs coaxially to the rotational axis. This design of the gripping element simultaneously enables a light decoupling acting with particular high quality in an optically very high quality design of the actuation element, the light decoupling being directed into the region that is supplied with the air vent depending on the pivoting of the air conducting elements and the alignment of the rotational axis of the actuation element connected to this in a vehicle interior chamber.

Exemplary embodiments of the invention are explained in more detail below by means of the drawings.

### BRIEF DESCRIPTION OF THE DRAWING FIGURES

Here are shown:

FIG. 1, schematically, a perspective view of an air outflow arrangement of an air vent,

FIG. 2, schematically, a sectional depiction of an air vent,

FIG. 3, schematically, an enlarged cut-out of the sectional depiction of the air vent according to FIG. 2,

FIG. 4, schematically, an enlarged cut-out of the sectional depiction of the air vent with an actuation element in a pivoted position,

FIG. 5, schematically, a perspective detailed view of an actuation element in a non-pivoted position and a cut-out of a shaft of the air vent according to FIG. 2 coupled to the actuation element,

FIG. 6, schematically, a side view of the actuation element in a pivoted and rotated position and of the cut-out of the shaft according to FIG. 5,

FIG. 7, schematically, a section depiction of the air vent according to FIG. 2 with an inner air conducting element in a pivoted position,

FIG. 8, schematically, a perspective view of the air vent according to FIG. 2 with an inner air conducting element and outer air conducting element in a non-pivoted position,

FIG. 9, schematically, a front view of the air vent according to FIG. 8 with an outer air conducting element in a pivoted position,

FIG. 10, schematically, a perspective view of an air outflow arrangement of the air vent according to FIG. 8 with an inner air conducting element in a pivoted position, and

FIG. 11, schematically, a front view of the air vent according to FIG. 8 with an inner air conducting element and outer air conducting element in a pivoted position.

Parts corresponding to one another are provided with the same reference numerals in all figures.

### DETAILED DESCRIPTION

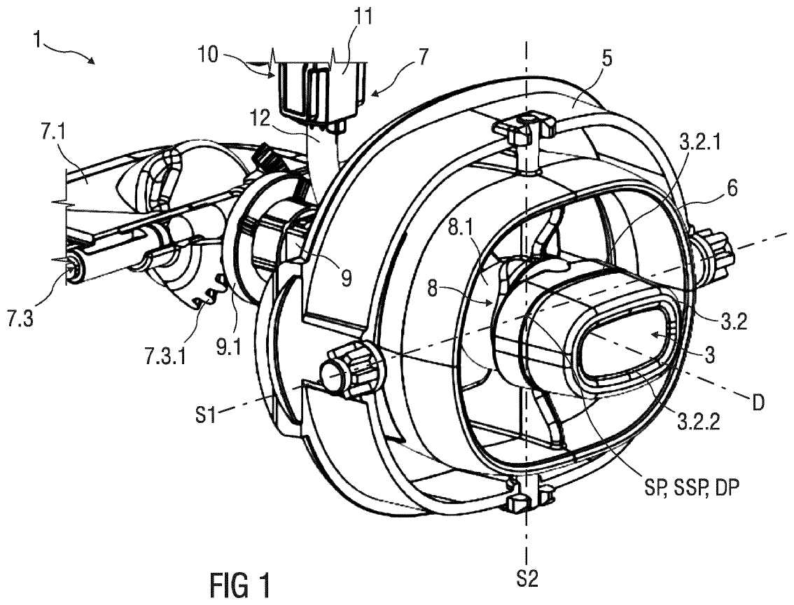

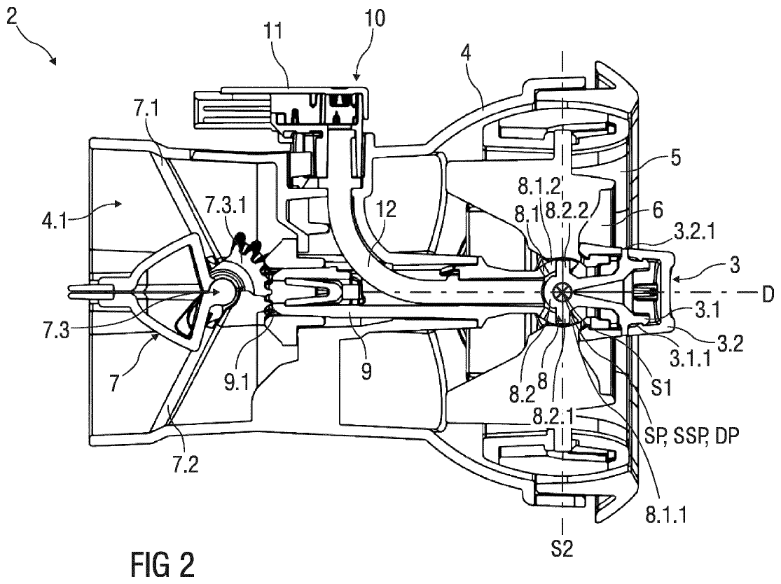

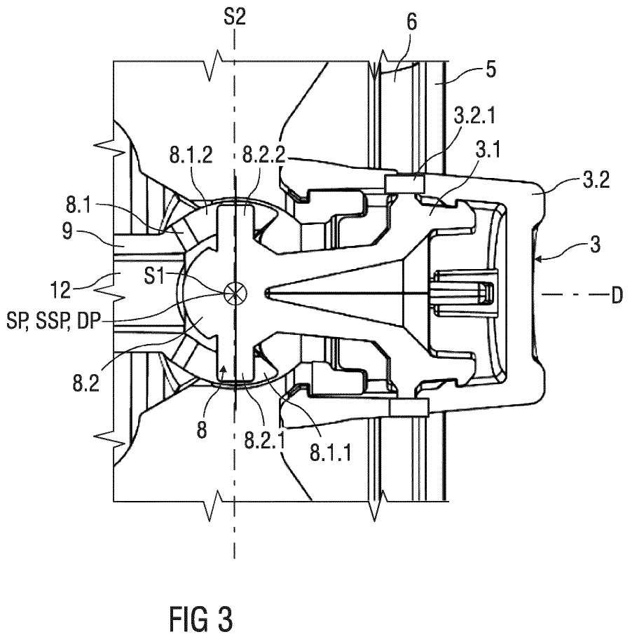

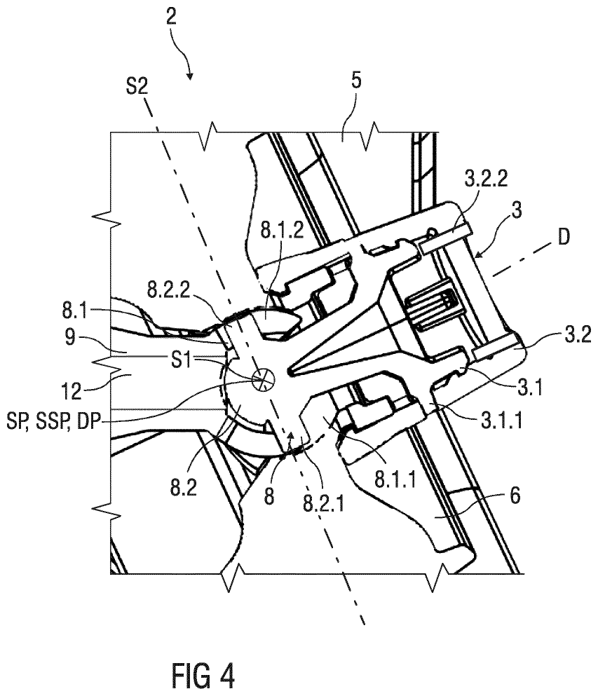

A perspective view of a possible exemplary embodiment of an air outflow arrangement 1 of an air vent 2 shown in FIG. 2 for a vehicle is depicted in FIG. 1. FIG. 2 shows a sectional depiction of a possible exemplary embodiment of an air vent 2 having an air outflow arrangement 1 according to FIG. 1, wherein the air vent 2 is cut along a sectional plane running vertically in its vertical direction. FIGS. 3 and 4 show enlarged cut-outs of the sectional depiction of the air vent 2 according to FIG. 2 with an actuation element 3 in a non-pivoted position (FIG. 3) and in a pivoted position (FIG. 4).

The air vent 2 comprises a housing 4, which has a channel 4.1 that air can flow through via which the air can be supplied to an interior chamber of the vehicle.

The air outflow arrangement 1 is arranged inside the housing 4, the air outflow arrangement comprising a roller-shaped outer air conducting element 5 and roller-shaped inner air conducting element 6.

Here, the outer air conducting element 5 can be pivoted in relation to the housing 4 around a pivoting axis S1 running transversely to a current direction predetermined by the channel 4.1.

The inner air conducting element 6 can be pivoted in relation to the outer air conducting element 5 and the housing 4 around a pivoting axis S2 running transversely to the current direction predetermined by the channel 4.1. This pivoting axis S2 runs perpendicularly to the pivoting axis S1 of the outer air conducting element 5, wherein the inner air conducting element 6 is mounted pivotably in the outer air conducting element 5. Here, the pivoting axes S1, S2 intersect at an intersection SP. A pivoting of the air conducting elements 5, 6 causes a change of the outflow direction of the air.

In order to operate the air conducting elements 5, 6, these are coupled to the central actuation element 3, wherein a corresponding pivoting movement of the air conducting elements 5, 6 is caused by a pivoting movement of the actuation element 3. The coupling of the actuation element 3 to the outer air conducting element 5 is carried out indirectly, for example, via the coupling to the inner air conducting element 6, which in turn is mounted on the outer air conducting element 5.

For this pivoting of the actuation element 3, a bearing 8 arranged centrally in the air vent 2 is provided, the bearing comprising a spherically formed first bearing segment 8.1 fixed at least indirectly on the housing 4 and a spherical second bearing segment 8.2 fixed on the actuation element 3 and corresponding to the first bearing segment 8.1. In the exemplary embodiment depicted, the first bearing segment 8.1 is formed as a ball cup, and the second bearing segment 8.2 is formed as a ball corresponding to the ball cup. Alternatively, in a manner not depicted, the second bearing segment 8.2 is formed as a ball cup and the first bearing segment 8.1 is formed as a ball corresponding to the ball cup.

In addition, the actuation element 3 is coupled to a flap arrangement 7, wherein a rotating movement of the actuation element 3 around a rotational axis D causes a control of the flap arrangement 7 and thus a change of a free cross-section of the channel 4.1. In order to set the free cross-section of the channel 4.1, the flap arrangement 7 comprises at least one flap 7.1, in the exemplary embodiment depicted two flaps 7.1, 7.2, which are pivotably arranged inside the channel 4.1 to change the free cross-section.

To pivot the flaps 7.1, 7.2, these are coupled to a drive 7.3, which comprises a serration 7.3.1. The actuation element 3 is coupled to a rotatable shaft 9, which comprises a spur gear serration 9.1 on an end facing away from the actuation element 3, the spur gear serration being in engagement with the serration 7.3.1 of the drive 7.3 of the flap arrangement 7. Here, the rotational movement of the actuation element 3 around the rotation axis D causes a rotational movement of the shaft 9 and a transmission of the rotation to the drive 7.3 of the flap arrangement 7 for pivoting the flaps 7.1, 7.2.

To transfer a rotational torque from the actuation element 3 to the shaft 9, the shaft 9 is coupled to the spherical first bearing segment 8.1, or comprises this, on the end facing towards the actuation element 3.

In order to simultaneously enable the pivoting of the actuation element 3 to pivot the air conducting elements 5, 6 around their pivoting axes S1, S2 and a rotational torque transfer to the shaft 9, two of these radially protruding spigots 8.2.1, 8.2.2 are arranged on an outside of the second bearing segment 8.2 formed as a ball. Furthermore, two slot-shaped recesses 8.1.1, 8.1.2 running in the peripheral direction of the wall perpendicularly to the rotational direction of the actuation element 3 are arranged on a wall of the first bearing segment 8.1 formed as a ball cup, wherein the spigots 8.2.1, 8.2.2 each protrude into a recess 8.1.1, 8.1.2 and thus are in mechanical engagement with the ball cup. The recesses 8.1.1, 8.1.2 here release a pivoting path around the first pivoting axis S1 and/or the second pivoting axis S2 depending on a rotational position of the actuation element 3, however the spigots 8.2.1, 8.2.2 are fixed in their position in relation to the rotational axis D of the actuation element 3, such that a transfer of the rotational torque when rotating the actuation element 3 around the rotational axis D to the shaft 9 is carried out.

Furthermore, the air vent 2 comprises an illuminating device 10, which is formed to decouple light starting from the actuation element 3 outwardly in the direction of the inner air conducting element 6 and the outer air conducting element 4 and thus to indirectly illuminate the outer and the inner air conducting element 5, 6. Furthermore, the illuminating device 10 is formed to decouple light in the running direction of the rotational axis D of the actuation element 3 into the interior chamber of the vehicle.

In order to achieve such an illumination without an illuminant having to be arranged moveably in the air vent 2, the illuminating device 10 comprises a light source 11 arranged outside the housing 4, for example a light diode. The light source 11 is formed to emit light in different colors. A color of the light can be freely selected, for example by a vehicle occupant, or is automatically predetermined.

In order to conduct the light of the light source 11 to the actuation element 3, the light source 11 is optically coupled to a light conductor 12, wherein the light source 11 couples the light into the light conductor 12. The light conductor 12 is guided from the light source 11 through the housing 4 into the inside thereof and through a predetermined opening into the inside of the shaft 9, which is formed as a hollow shaft and sectionally coaxially surrounds the light conductor 12. The light conductor 12 is optically coupled to the first bearing segment 8.1 on an end facing away from the light source 11.

In order to decouple the light, the actuation element 3 comprises an illuminating element 3.1, which is surrounded at least sectionally by a gripping element 3.2. The illuminating element 3.1 is formed, in particular, as a light conductor and/or as a scattering element.

In order to optically couple the illuminating element 3.1 to the light conductor 12, the first bearing segment 8.1 comprises a light decoupling surface and the second bearing segment 8.2, which is, in particular, a component of the illuminating element 3.1, a corresponding light coupling surface. This means that the illuminating element 3.1 unites illumination and cinematic functions.

In order to enable the conducting of the light in each pivoted and/or rotated position of the actuation element 3 and the air conducting elements 5, 6 without limiting or preventing a pivoting or a rotation, a pivoting point SSP and a rotating point DP of the bearing 8, i.e., a central point thereof, coincide with an imaginary intersection SP of the pivoting axes S1, S2 of the air conducting elements 5, 6.

In order to decouple the light in the direction of the air conducting elements 5, 6, the gripping element 3.2 comprises a peripheral translucent or transparent light decoupling section 3.2.1 running coaxially in relation to the rotational axis D of the actuation element 3 and directed away from the rotational axis D, the light decoupling section decoupling light decoupled inside the gripping element 3.2 by means of the illuminating element 3.1. For example, the light decoupling section 3.2.1 is formed as a peripheral groove into which a light distributing arm 3.1.1 of the illuminating element 3.1 is fitted. Along with achieving the illumination, the arrangement of the light distributing arm 3.1.1 in the groove here also enables a force transfer from the gripping element 3.2 to the shaft 9 and thus the flap arrangement 7. This design is depicted in more detail in FIG. 3.

In order to decouple light in the running direction of the rotational axis D of the actuation element 3 into the interior chamber of the vehicle, the air vent 2 alternatively or additionally comprises a gripping element 3.2, which comprises a translucent or transparent light decoupling section 3.2.2, which decouples light decoupled inside the gripping element 3.2 in the running direction of the rotational axis D by means of the illuminating element 3.1. Here, the light decoupling section 3.2.2 runs coaxially to the rotational axis D. This design is depicted in more detail in FIG. 4, wherein the actuation element 3 and thus the two air conducting elements 5, 6 are pivoted upwardly around the pivoting axis S1. A possible pivoting angle is here 25°, for example, based on an average, non-pivoted position, as shown in FIG. 3.

In order to generate particular light effects of the air conducting elements 5, 6, these are formed to be at least sectionally reflected on their visible sides in one possible design.

In FIG. 5, a perspective detailed view of the actuation element 3 in a non-pivoted position and a cut-out of the shaft 9, coupled to the actuation element 3, of the air vent 2 according to FIG. 2 is depicted.

The detailed view illustrates the arrangement of the spigots 8.2.1, 8.2.2 of the slot-shaped recesses 8.1.1, 8.1.2, into which the spigots 8.2.1, 8.2.2 respectively protrude. The recesses 8.1.1, 8.1.2 here presently release a pivoting path around the first pivoting axis S1, however the spigots 8.2.1, 8.2.2 are fixed in their position in relation to the rotational axis D of the actuation element 3, such that a transfer of the rotational torque when rotating the actuation element 3 around the rotational axis D to the shaft 9 can be carried out.

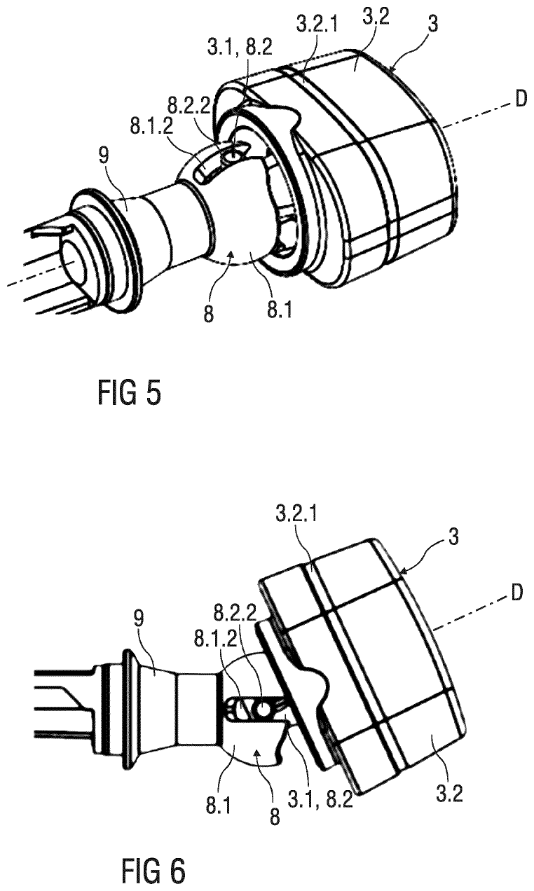

FIG. 6 shows a side view of the actuation element 3 according to FIG. 5 in a position pivoted around the pivoting axis S1 and rotated by 90° in comparison to the depiction in FIG. 5 and the cut-out of the shaft 9.

In this position, the recesses 8.1.1, 8.1.2 release a pivot path around the second pivoting axis S2, however the spigots 8.2.1, 8.2.2 are fixed in their position in relation to the rotational axis D of the actuation element 3, such that a transfer of the rotation torque when rotating the actuation element 3 around the rotational axis D to the shaft 9 can be carried out.

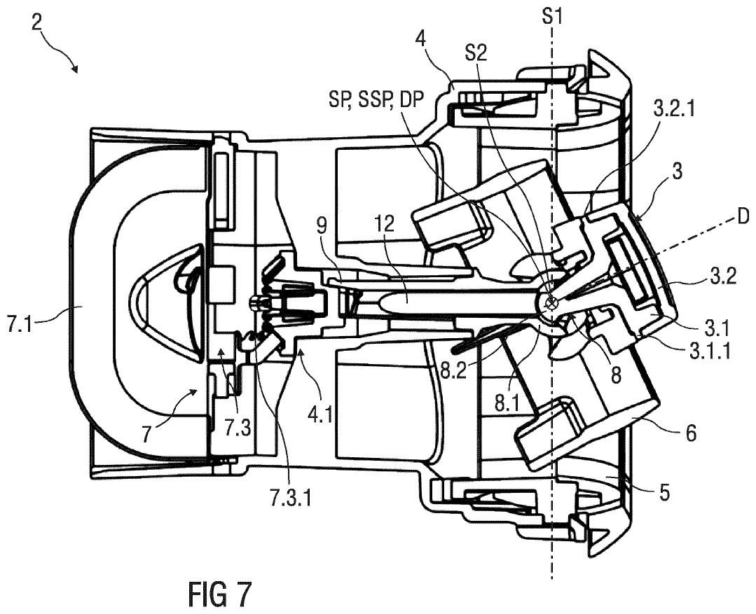

In FIG. 7, a sectional depiction of the air vent 2 according to FIG. 2 is depicted, wherein the air vent 2 is cut along a sectional plane running horizontally in its transverse direction. Here, the actuation element 3 and the inner air conducting element 6 are pivoted starting from the non-pivoted starting position depicted in FIG. 2, for example around a pivoting angle of 25°.

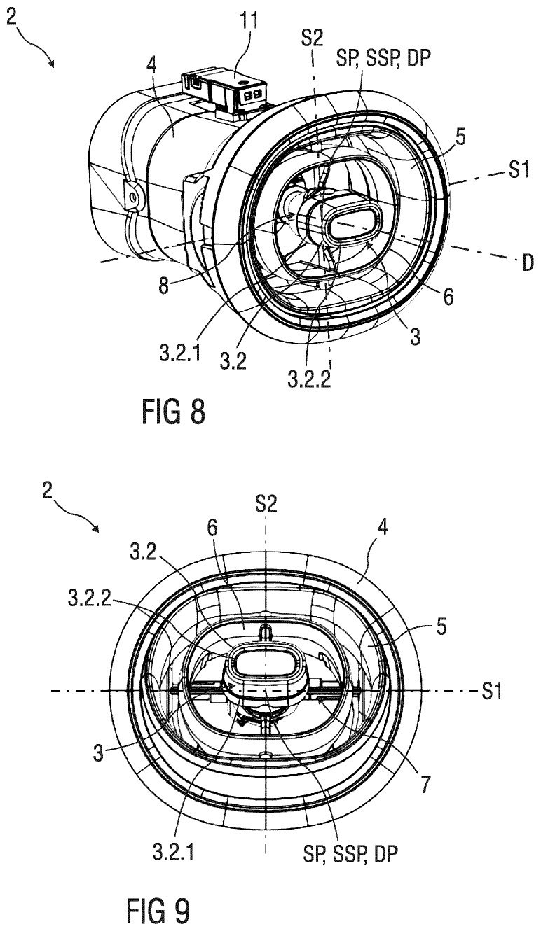

FIG. 8 shows a perspective view of the air vent 2 according to FIG. 2 having an inner air conducting element 6 and outer air conducting element 5 in a non-pivoted position.

In FIG. 9, a front view of the air vent 2 according to FIG. 8 having an outer air conducting element 5 in a position pivoted around the pivoting axis S1 is depicted. Here, the actuation element 3, the outer air conducting element 6 and, with this, the inner air conducting element 6 are pivoted starting from the non-pivoted starting position depicted in FIG. 8, for example around a pivoting angle of 25°.

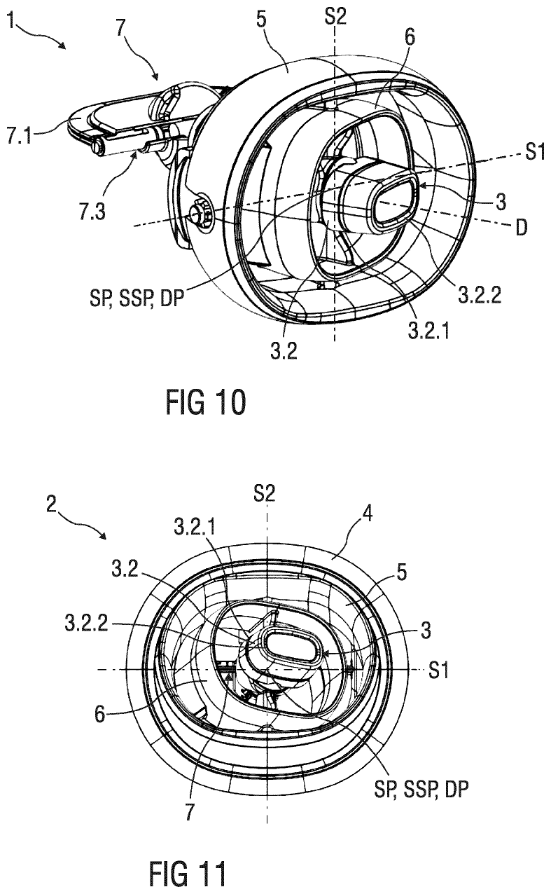

FIG. 10 shows a perspective view of an air vent arrangement 1 of the air vent 2 according to FIG. 8 with an inner air conducting element 6 in a pivoted position, wherein the actuation element 3 and the inner air conducting element 6 are pivoted starting from the non-pivoted starting position depicted in FIG. 8 around the pivoting axis S2 around a pivoting angle of 25°, for example.

In FIG. 11, a front view of the air vent 2 according to FIG. 8 with an inner air conducting element 6 in a pivoted position and an outer air conducting element 5 are depicted. Here, the actuation element 3, the outer air conducting element 5 and, with this, the inner air conducting element 6 are pivoted starting from the non-pivoted starting position depicted in FIG. 8 for example around a pivoting angle of 25° around the pivoting axis S1. In addition, the actuation element 3 and the inner air conducting element 6 are pivoted around the pivoting axis S2 around a pivoting angle of 25°, for example.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. An air vent for a vehicle, the air vent comprising:
a housing having a channel configured so that air can flow through the channel;
an air conducting element, which is pivotable relative to the housing around a first pivoting axis running transversely to a current direction predetermined by the channel;
an illuminating device comprising an illuminating element, a light source arranged outside the air conducting element, and a light conductor optically coupled to the light source and the illuminating element;
a bearing comprising a spherically formed first bearing segment fixed at least indirectly on the housing and a spherical second bearing segment fixed or formed on the illuminating element and corresponding to the first bearing segment, wherein the second bearing segment is mounted pivotably and/or rotatably on the first bearing segment, wherein the first bearing segment comprises a light decoupling segment configured to optically couple the illuminating element to the light conductor, and the second bearing segment comprises a light coupling element,
wherein the air conducting element is a roller-shaped outer air conducting element,
wherein a wall of the outer air conducting element surrounds a wall of a roller-shaped inner air conducting element,
wherein the inner air conducting element is pivotable relative to the outer air conducting element and the housing around a second pivoting axis running transversely to the current direction predetermined by the channel, wherein the second pivoting axis runs perpendicularly to the first pivoting axis of the outer air conducting element, and
wherein a pivoting point or rotating point of the bearing coincide or coincides with an imaginary intersection of the first and second pivoting axes.

11. The air vent of claim 10, wherein the illuminating element is configured to at least sectionally illuminate a visible side of the outer air conducting element or to at least sectionally illuminate a visible side of the inner air conducting element.

12. The air vent of claim 10, wherein
the illuminating element is a component of an actuating element arranged centrally between the wall of the inner air conducting element or forms the wall of the inner air conducting element,
the actuating element is mechanically coupled to the outer air conducting element and the inner air conducting element and pivoting around the bearing causes a pivoting of the outer air conducting element or the inner air conducting element around the respectively corresponding first or second pivoting axis.

13. The air vent of claim 12, further comprising:
a flap arrangement arranged in the channel and having at least one flap, which is pivotably arranged inside the channel to change a free cross-section of the channel.

14. The air vent of claim 13, wherein the actuating element is coupled to a rotatable shaft, which
coaxially surrounds the light conductor at least sectionally,
comprises a spur gear serration on an end facing away from the actuation element, the spur gear serration being engaged with a serration of a drive of the flap arrangement, wherein a rotating movement of the actuating element causes a rotating movement of the shaft and a transfer of the rotation to the drive of the flap arrangement to pivot the at least one flap.

15. The air vent of claim 14, wherein the shaft is coupled to the first bearing segment on an end facing away from the actuating element or comprises the first bearing segment.

16. The air vent of claim 10, wherein
the first bearing segment is a ball cup and the second bearing segment is a ball corresponding to the ball cup or the second bearing segment is a ball cup and the first bearing segment is a ball corresponding to the ball cup,
at least one radially protruding spigot is arranged on an outside of the ball,
at least one slot-shaped recess running in a peripheral direction of the wall perpendicularly to a rotational direction of the actuating element is arranged on a wall of the ball cup, and
the at least one radially protruding spigot protrudes into the at least one slot-shaped recess and is in mechanical engagement with the ball cup.

17. The air vent of claim 12, wherein
the actuating element comprises a gripping element at least sectionally surrounding the illuminating element, and
the gripping element comprises a peripheral translucent or transparent light decoupling section running coaxially to a rotational axis of the actuating element and directed away from the rotational axis of the actuating element, wherein the light decoupling section decouples light decoupled inside the gripping element by the illuminating element.

18. The air vent of claim 12, wherein
the actuating element comprises a gripping element at least sectionally surrounding the illuminating element, and
the gripping element comprises a translucent or transparent light decoupling section, that decouples light decoupled inside the gripping element by the illuminating element in a running direction of a rotational axis of the actuating element.
